(19) United States
(12) Patent Application Publication
(10) Pub. No.: US 2013/0094514 A1
(43) Pub. Date: Apr. 18, 2013

(54) METHOD AND SWITCH FOR SENDING PACKET

(71) Applicant: Huawei Technologies Co., Ltd., Shenzhen (CN)

(72) Inventor: Zhaoyuan TAN, Shenzhen (CN)

(73) Assignee: HUAWEI TECHNOLOGIES CO., LTD., Shenzhen (CN)

(21) Appl. No.: 13/626,556

(22) Filed: Sep. 25, 2012

(30) Foreign Application Priority Data
Oct. 18, 2011 (CN) 201110316270.X

(51) Int. Cl. H04L 12/28

(52) U.S. Cl. 370/395.53

(57) ABSTRACT

The present disclosure discloses a method and a switch for sending a packet, which belongs to the field of computer network technologies. A layer 3 switch which is configured with an aggregated VLAN containing a plurality of VLANs searches information regarding correspondence between IP addresses and the VLANs to determine if there is a VLAN in the aggregated VLAN that corresponds to a target IP address in a packet; if there is a VLAN that corresponds to the target IP address, sends the packet to only that VLAN. In the technical solutions of the present disclosure, the number of invalid packets that are sent can be effectively reduced, thereby reducing an influence of the invalid packets on the whole virtual local area network.

### CROSS-REFERENCE TO RELATED APPLICATION

This application claims priority to Chinese Patent Application No. 201110316270.X, filed on Oct. 18, 2011, which is hereby incorporated by reference in its entirety.

### FIELD

The present disclosure relates to the field of computer network technologies, and in particular, to a method and switch for sending a packet.

### BACKGROUND

At present, a layer 3 switch is usually adopted to accelerate data exchange inside a VLAN (Virtual Local Area Network). The layer 3 switch may serve as a gateway of a user, and implement high-speed forwarding of a layer 3 data packet in an OSI (Open Systems Interconnection Reference Model) network model.

In order to implement high-speed forwarding of layer 3 data packets, when VLANs are built, the layer 3 switch needs to configure a VLAN IF (a logical port of a virtual local area network) which corresponds to each VLAN, and allocate a corresponding IP (Internet Protocol) network segment for each configured VLAN IF, where each of the allocated IP network segments correspondingly keeps one IP address as a broadcast address of this IP network segment. It can be known from the foregoing description that, since each VLAN is correspondingly allocated with a corresponding IP network segment, and each IP network segment correspondingly keeps one IP address as the broadcast address of this IP network segment, when the number of VLANs is relatively large, a lot of IP addresses may be wasted.

In the prior art, in order to solve the problem of the waste of IP addresses, VLAN aggregation technology is proposed. Multiple VLANs are aggregated into one aggregated VLAN; and afterwards, a VLAN IF is allocated only for the aggregated VLAN obtained by aggregation, and an IP network segment corresponding to the VLAN IF is allocated, where the IP network segment keeps one IP address as the broadcast address of this IP network segment. It can be seen that, after the processing of the VLAN aggregation technology, the layer 3 switch only allocates one IP network segment for the VLANs, and the IP network segment only keeps one IP address as the broadcast address, thereby effectively preventing the waste of the IP addresses.

In the aggregated VLAN, when the layer 3 switch needs to send a packet, for example, an ARP (Address resolution protocol, address resolution protocol) request packet, to a certain connected user, because the layer 3 switch does not know a specific VLAN which corresponds to the IP address of the user, the layer 3 switch needs to replicate the packet in all the VLANs, and then sends each replicated packet to each VLAN, respectively. For example, in order that the layer 3 switch obtains ARP information of all connected users, the number of packets that the layer 3 switch needs to send is: the number of VLANs in VLAN aggregation×the number of all the connected users. However, one user only belongs to one VLAN. Therefore, (the number of VLANs in VLAN aggregation−1)×the number of all the connected users) packets are invalid packets, which may seriously affect processing performance of the layer 3 switch, and these invalid packets may further cause a processing burden for the network and other devices in the network.

### SUMMARY

In order to avoid sending of invalid packets and improve sending performance of a packet in an aggregated VLAN scenario, embodiments of the present disclosure provide a method and switch for sending a packet. The technical solutions are as follows.

According to a first aspect of the present disclosure, a method for sending a packet is provided, where the method is performed by a layer 3 switch configured with an aggregated virtual local area network (VLAN) containing a plurality of VLANs, and the method includes:

searching information regarding correspondence between IP addresses and the VLANs to determine if there is a VLAN in the aggregated VLAN that corresponds to a target IP address in a packet; and

if there is a VLAN that corresponds to the target IP address, sending the packet to only that VLAN.

According to a first aspect of the present disclosure, a layer 3 switch is provided, where the switch is configured with an aggregated virtual local area network (VLAN) containing a plurality of VLANs and includes: a searching module and a transmitter;

the searching module is configured to, search information regarding correspondence between IP addresses and the VLANs to determine if there is a VLAN in the aggregated VLAN that corresponds to a target IP address in a packet; and

the transmitter is configured to, if the searching module obtains a VLAN that corresponds to the target IP address, send the packet to only that VLAN.

In the embodiments of the present disclosure, with the implementation of the technical solutions that correspondence between IP address information and virtual local area networks is searched according to a target Internet protocol (IP) address in a packet, and when a virtual local area network corresponding to the target IP address is obtained by searching according to the target IP address, the packet is sent to the virtual local area network, and otherwise, the packet is sent to all the virtual local area networks. The number of invalid packets that are sent can be effectively reduced, and sending performance of the packet in an aggregated VLAN scenario is improved, thereby reducing an influence of the invalid packets on the whole virtual local area network.

### BRIEF DESCRIPTION OF THE DRAWINGS

To illustrate the technical solutions according to the embodiments of the present disclosure more clearly, the accompanying drawings required for describing the embodiments are briefly introduced in the following. Apparently, the accompanying drawings in the following description are only some embodiments of the present disclosure, and persons skilled in the art may further derive other accompanying drawings according to these accompanying drawings without making creative efforts.

FIG. 1 is a flow chart of a method for sending a packet according to Embodiment 1 of the present disclosure;

FIG. 2 is a schematic diagram of networking of an aggregated VLAN connected by layer 3 switches, which corresponds to Embodiment 2 of the present disclosure;

FIG. 3 is a flow chart of a method for sending a packet according to Embodiment 2 of the present disclosure;

FIG. 4 is a flow chart of a method for sending a packet according to Embodiment 2 of the present disclosure;

FIG. 5 is a schematic diagram of networking of an aggregated VLAN connected by layer 3 switches, which corresponds to Embodiment 2 of the present disclosure;

FIG. 6 is a flow chart of a method for sending a packet according to Embodiment 2 of the present disclosure;

FIG. 7 is a flow chart of a method for sending a packet according to Embodiment 2 of the present disclosure;

FIG. 8 is a switch according to Embodiment 3 of the present disclosure; and

FIG. 9 is a switch according to Embodiment 3 of the present disclosure.

### DETAILED DESCRIPTION OF THE EMBODIMENTS

To make the objectives, technical solutions, and advantages of the present disclosure clearer, implementation manners of the present disclosure are further described in detail in the following with reference to the accompanying drawings.

### Embodiment 1

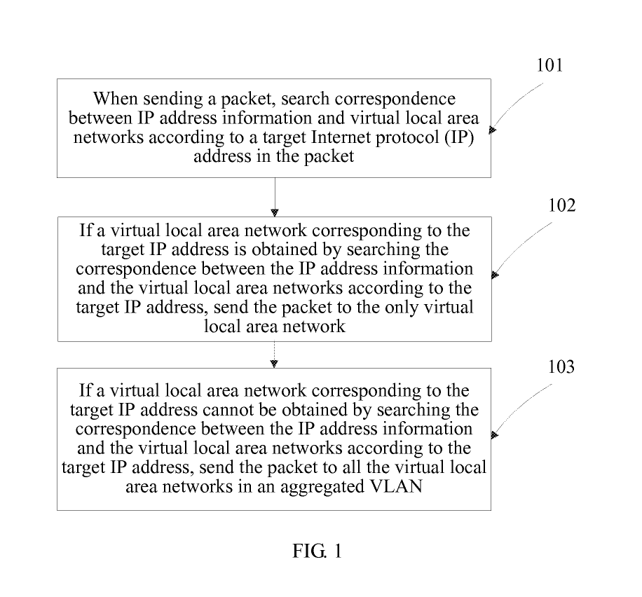

Referring to FIG. 1, a method for sending a packet is shown. The method is as follows:

Step 101: When sending a packet, search correspondence between IP address information and virtual local area networks according to a target Internet protocol (IP) address in the packet.

Step 102: If a virtual local area network corresponding to the target IP address is obtained by searching the correspondence between the IP address information and the virtual local area networks according to the target IP address, send the packet to the only obtained virtual local area network.

Step 103: If a virtual local area network corresponding to the target IP address cannot be obtained by searching the correspondence between the IP address information and the virtual local area networks according to the target IP address, send the packet to all the virtual local area networks in an aggregated VLAN.

In the embodiment of the present disclosure, with the implementation of the technical solutions that correspondence between IP address information and virtual local area networks is searched according to a target Internet protocol (IP) address in a packet, and when a virtual local area network corresponding to the target IP address is obtained by searching according to the target IP address, the packet is sent to the virtual local area network, and otherwise, the packet is sent to all the virtual local area networks. The number of invalid packets that are sent may be effectively reduced, and sending performance of the packet in an aggregated VLAN scenario is improved, thereby reducing an influence of the invalid packets on the whole virtual local area network.

### Embodiment 2

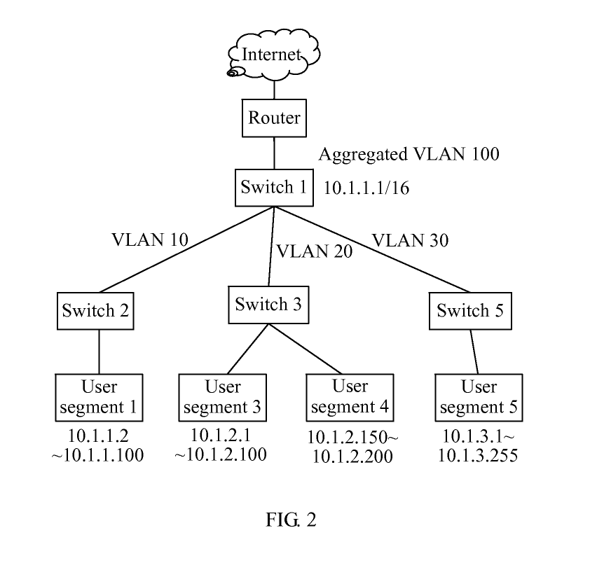

Referring to FIG. 2, it is a schematic diagram of networking of an aggregated VLAN connected by layer 3 switches, which corresponds to an embodiment of the present disclosure. The aggregated VLAN shown in FIG. 2 includes three virtual local area networks, which are VLAN 10, VLAN 20, and VLAN 30, that is, the VLAN 10, the VLAN 20, and the VLAN 30 all join an aggregated VLAN 100. The aggregated VLAN 100 is correspondingly configured with a VLAN IF (a logical port of the virtual local area network). The VLAN 10, the VLAN 20 and the VLAN 30 and the aggregated VLAN 100 are connected by layer 3 switches 2, 3, 5, and 1, respectively, layer 3 switch 1 is configured with the aggregated VLAN 100.

In the embodiment of the present disclosure, a network administrator of the aggregated VLAN network may statically configure one or more corresponding IP network segments for the aggregated VLAN and each virtual local area network in the aggregated VLAN, where the IP network segment corresponding to the aggregated VLAN includes the IP network segment corresponding to each virtual local area network in the aggregated VLAN. In a case of statically configuring the IP network segment in the foregoing, when a user device joins a certain VLAN, the network administrator may select an unoccupied IP address from the IP network segment corresponding to the VLAN and statically allocate the IP address to the newly joined user device.

Referring to FIG. 2, an IP network segment allocated for the VLAN 10 by the network administrator is 10.1.1.2 to 10.1.1.100, IP network segments allocated for the VLAN 20 are 10.1.2.1 to 10.1.2.100 and 10.1.2.150 to 10.1.2.200, an IP network segment allocated for the VLAN 30 is 10.1.3.1 to 10.1.3.255, and an IP network segment allocated for the aggregated VLAN 100 is 10.1.1.1/16. In this way, when a user device 1 joins the VLAN 10 network, the network administrator may select an IP address, for example, 10.1.1.5, from 10.1.1.2 to 10.1.1.100 and allocate the IP address to the user device 1.

In the embodiment of the present disclosure, a layer 3 switch may implement high-speed forwarding of a layer 3 data packet in an OSI network model. A layer 3 in the OSI network model refers to a network layer. In the aggregated VLAN, a packet forwarded by the layer 3 switch usually includes content such as a source IP address, a destination IP address, and aggregated VLAN information. When the layer 3 switch forwards a packet, the packet is forwarded, according to the destination IP address in the forwarded packet, to a user device identified by the destination IP address, thereby implementing the high-speed forwarding of the layer 3 data packet.

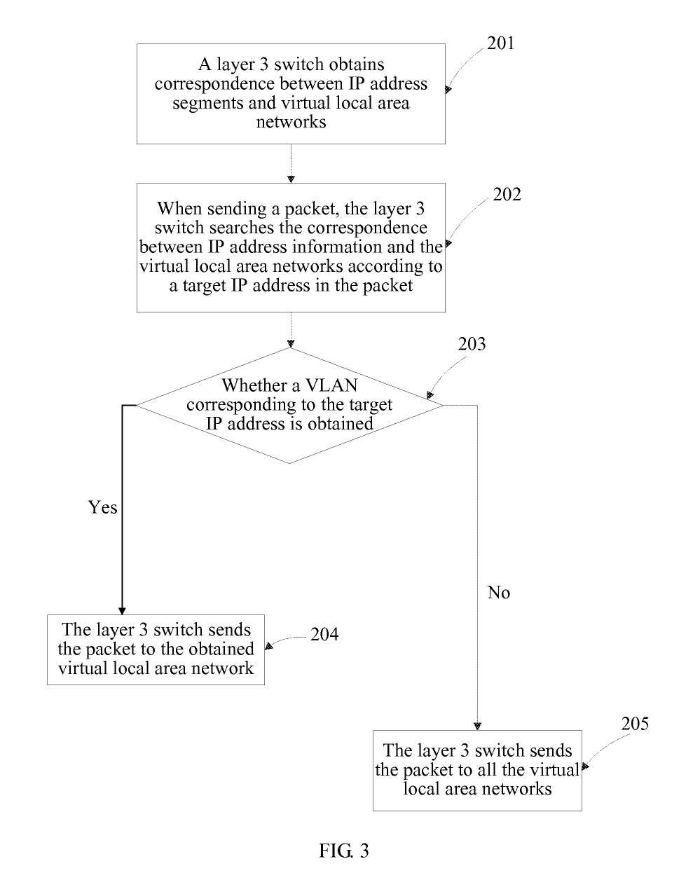

For a case that the IP address of the user device in the VLAN is statically allocated, the embodiment of the present disclosure provides a method for sending a packet, and the method for sending the packet is applicable to the aggregated VLAN shown in FIG. 2. In addition, referring to FIG. 3, the following steps are included:

Step 201: The layer 3 switch which is configured with an aggregated VLAN obtains correspondence between IP address information and virtual local area networks. In the embodiment of the present disclosure, the correspondence between the IP address information and the virtual local area networks is correspondence between IP address segments and the virtual local area networks, and IP addresses in an IP address segment may be continuous IP addresses.

The obtaining, by the layer 3 switch, the correspondence between the IP address information and the virtual local area networks includes: configuring and saving, by the layer 3 switch, the correspondence between the IP address segments and the virtual local area networks.

In specific implementation of this step, the layer 3 switch provides a configuration interface and provides a corresponding configuration command for a user, so that the user can configure the correspondence between the IP address segments and the virtual local area networks through the configuration command provided by the layer 3 switch; and through the configuration interface, the layer 3 switch receives the correspondence which is between the IP address segments and the virtual local area networks and is configured by the user, and saves the correspondence which is between the IP address segments and the virtual local area networks and is configured by the user. The user here mainly refers to the network administrator.

In the embodiment of the present disclosure, the correspondence which is between the IP address segments and the virtual local area networks and is configured by the user and is saved by the layer 3 switch may be shown in Table 1.

TABLE 1
Correspondence between IP address segments
and virtual local area networks

| IP Address Segment | Virtual Local Area Network |
|---|---|
| 10.1.1.2 to 10.1.1.100 | VLAN 10 |
| 10.1.2.1 to 10.1.2.100 | VLAN 20 |
| 10.1.2.150 to 10.1.2.200 | |
| 10.1.3.1 to 10.1.3.100 | VLAN 30 |
| . . . | . . . |

In the embodiment of the present disclosure, the layer 3 switch allows the user to modify, for a second time, the correspondence which is between the IP address segments and the virtual local area networks and is configured by the user, and at the same time, the layer 3 switch updates its saved correspondence between the IP address segments and the virtual local area networks according to the modification of the user.

Step 202: When sending a packet, the layer 3 switch searches the correspondence between the IP address information and the virtual local area networks according to a target IP address in the packet.

The layer 3 switch determines an IP address segment to which the target IP address belongs, and searches the correspondence between the IP address segments and the virtual local area networks according to the determined IP address segment.

Step 203: The layer 3 switch judges whether a virtual local area network corresponding to the target IP address is obtained by searching the correspondence between the IP address information and the virtual local area networks according to the target IP address in the packet.

If the virtual local area network corresponding to the target IP address is obtained by searching the correspondence between the IP address information and the virtual local area networks according to the target IP address, execute step 204.

If the virtual local area network corresponding to the target IP address cannot be obtained by searching the correspondence between the IP address information and the virtual local area networks according to the target IP address, execute step 205.

For example, if the packet forwarded by the layer 3 switch is an ARP request packet, and the target IP address in the packet is 10.1.2.180, the layer 3 switch searches the stored correspondence between IP address segments and virtual local area networks according to the target IP address. Since the target IP address is located in an IP segment of 10.1.2.150 to 10.1.2.200, while a virtual local area network corresponding to the IP segment of 10.1.2.150 to 10.1.2.200 is the VLAN 20, it can be known that the virtual local area network corresponding to the target IP address of 10.1.2.180 is the VLAN 20.

Step 204: The layer 3 switch sends the packet to the obtained virtual local area network.

Step 205: The layer 3 switch sends the packet to all the virtual local area networks in the aggregated VLAN.

In the embodiment of the present disclosure, before the layer 3 switch sends a packet, with the implementation of the technical solutions that correspondence between IP address information and virtual local area networks is searched according to a target Internet protocol (IP) address in the packet, and when a virtual local area network corresponding to the target IP address is obtained by searching according to the target IP address, the packet is sent to the virtual local area network, and otherwise, the packet is sent to all the virtual local area networks. The number of invalid packets sent by the layer 3 switch may be effectively reduced, and the sending performance of the packet in an aggregated VLAN scenario is improved, thereby reducing an influence of the invalid packets on the whole virtual local area network.

In the embodiment of the present disclosure, the IP address of the user device in each virtual local area network may be statically allocated by the network administrator, and may also be dynamically allocated by the layer 3 switch. Here, the layer 3 switch is a switch which has a DHCP (Dynamic Host Configuration Protocol, dynamic host configuration protocol) function.

The layer 3 switch dynamically allocates the IP address of the user device as follows:

First, the network administrator of the aggregated VLAN may designate one or more corresponding IP address pools for the aggregated VLAN and each virtual local area network in the aggregated VLAN, where IP addresses in the IP address pool may be a segment of continuous IP addresses; in addition, IP address information in the IP address pool which corresponds to the aggregated VLAN includes IP address information in the IP address pool which corresponds to each virtual local area network in the aggregated VLAN; and the layer 3 switch stores the correspondence which is between the IP address pools and the virtual local area networks and is configured by the network administrator.

Then, in a case that the layer 3 switch stores the correspondence which is between the IP address pools and the virtual local area networks and is configured by the network administrator, the user device applies for an IP address to the layer 3 switch, and the layer 3 switch allocates a corresponding IP address for the user device when receiving an application of the user device. The user device sends a DHCP DISCOVER (Discover packet) to the layer 3 switch, where the DHCP DISCOVER includes information of a virtual local area network where the user device is located; after receiving the DHCP DISCOVER, the layer 3 switch searches the correspondence between the IP address pools and the virtual local area networks according to the information of the virtual local area network where the user device is located, obtains an IP address pool corresponding to the virtual local area network where the user device is located, and selects an unoccupied IP address for the user device from the found IP address pool; and afterwards, the layer 3 switch returns a response packet DHCP OFFER (Offer packet) of the DHCP DISCOVER to the user device, where the DHCP OFFER packet is used to notify the user device of the allocated IP address, and the DHCP OFFER packet includes configuration information such as the IP address of the user device.

When IP address resources in the IP address pool, found by the layer 3 switch, corresponding to the virtual local area network, where the user device is located, are insufficient, an IP address which is unoccupied and is not in the IP address pools corresponding to another virtual local area network is selected for the user device from the IP address pool corresponding to the aggregated VLAN.

In addition, when the IP address pool corresponding to the virtual local area network where the user device is located cannot be obtained by searching the correspondence between the IP address pools and the virtual local area networks according to the information of the virtual local area network where the user device is located, an IP address which is unoccupied and is not in the IP address pools corresponding to another virtual local area network is selected for the user device from the IP address pool corresponding to the aggregated VLAN.

Referring to the networking which is of the aggregated VLAN connected by layer 3 switches and is shown in FIG. 2, an IP address pool allocated for the VLAN 10 by the network administrator is 10.1.1.2 to 10.1.1.100, IP address pools allocated for the VLAN 20 are 10.1.2.1 to 10.1.2.100 and 10.1.2.150 to 10.1.2.200, respectively, an IP address pool allocated for the VLAN 30 is 10.1.3.1 to 10.1.3.255, and an IP address pool allocated for the aggregated VLAN 100 is 10.1.1.1/16. For example, the user device 1 sends a DHCP DISCOVER message to a layer 3 switch 1, where the DHCP DISCOVER message includes identification information of the VLAN 20; after receiving the DHCP DISCOVER message, the layer 3 switch 1 searches the correspondence between the IP address pools and the virtual local area networks to obtain that the IP address pools corresponding to the VLAN 20 are 10.1.2.1 to 10.1.2.100 and 10.1.2.150 to 10.1.2.200, and then selects an unoccupied IP address, for example, 10.1.2.8, for the user device 1 from 10.1.2.1 to 10.1.2.100 and 10.1.2.150 to 10.1.2.200, and sends a DHCP OFFER message to the user device 1 to notify the user device 1 that its IP address is 10.1.2.8.

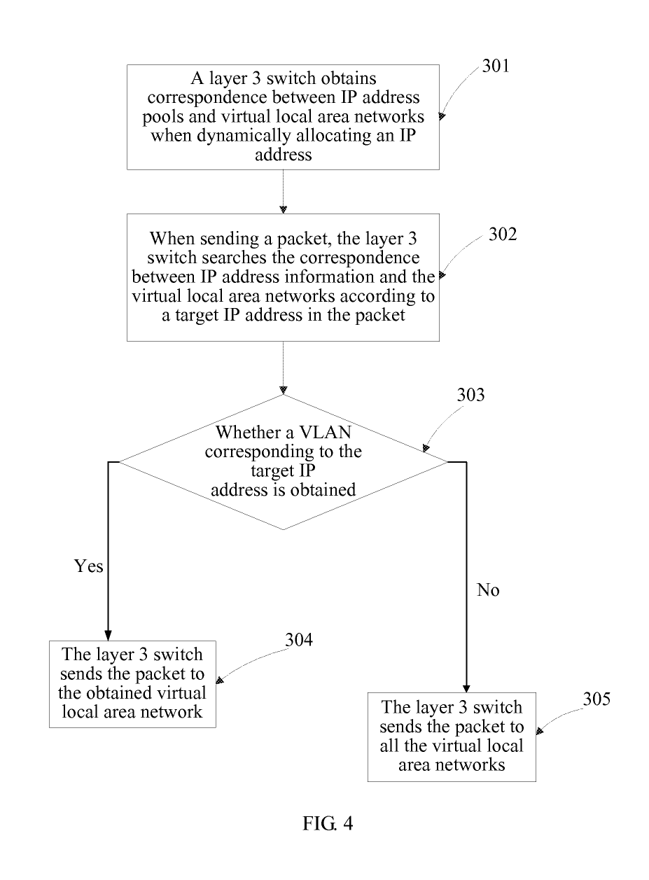

For a case that the IP address of the user device in the VLAN is dynamically allocated by the layer 3 switch, the embodiment of the present disclosure provides a method for sending a packet, and the method for sending the packet is applicable to the aggregated VLAN shown in FIG. 2. In addition, referring to FIG. 4, the following steps are included:

Step 301: A layer 3 switch which is configured with an aggregated VLAN obtains correspondence between IP address information and virtual local area networks. In the embodiment of the present disclosure, the correspondence between the IP address information and the virtual local area networks is correspondence between IP address pools and the virtual local area networks, and IP addresses in the IP address pool may be one or more segments of continuous IP addresses.

The obtaining, by the layer 3 switch, the correspondence between the IP address information and the virtual local area networks includes: configuring and saving the correspondence between the IP address pools and the virtual local area networks.

In specific implementation of this step, the layer 3 switch provides a configuration interface and provides a corresponding configuration command for the user, so that the user can configure the correspondence between the IP address pools and the virtual local area networks through the configuration command provided by the layer 3 switch; and through the configuration interface, the layer 3 switch receives the correspondence which is between the IP address pools and the virtual local area networks and is configured by the user, and saves the correspondence which is between the IP address pools and the virtual local area networks and is configured by the user. The user here mainly refers to the network administrator.

In the embodiment of the present disclosure, the correspondence which is between the IP address pools and the virtual local area networks and is configured by the user and is saved by the layer 3 switch may be shown in Table 2.

TABLE 2
Correspondence between IP address pools
and virtual local area networks

| IP Address Pool | Virtual Local Area Network |
|---|---|
| 10.1.1.2 to 10.1.1.100 | VLAN 10 |
| 10.1.2.1 to 10.1.2.100 | VLAN 20 |
| 10.1.2.150 to 10.1.2.200 | |
| 10.1.3.1 to 10.1.3.100 | VLAN 30 |
| . . . | . . . |

In the embodiment of the present disclosure, the layer 3 switch allows the user to modify, for a second time, the correspondence between the IP address pools and the virtual local area networks, and at the same time, the layer 3 switch updates its saved correspondence between the IP address pools and the virtual local area networks according to the modification of the user.

Step 302: When sending a packet, the layer 3 switch searches the correspondence between the IP address information and the virtual local area networks according to a target IP address in the packet.

The layer 3 switch determines an IP address pool to which the target IP address belongs, and searches the correspondence between the IP address pools and the virtual local area networks according to the determined IP address pool.

Step 303: The layer 3 switch judges whether a virtual local area network corresponding to the target IP address is obtained by searching the correspondence between the IP address information and the virtual local area networks according to the target IP address in the packet.

If the virtual local area network corresponding to the target IP address is obtained by searching the correspondence between the IP address information and the virtual local area networks according to the target IP address, execute step 304.

If the virtual local area network corresponding to the target IP address cannot be obtained by searching the correspondence between the IP address information and the virtual local area networks according to the target IP address, execute step 305.

For example, if the packet forwarded by the layer 3 switch is an ARP request packet, and the target IP address in the packet is 10.1.3.10, the layer 3 switch searches the stored correspondence between the IP address pools and the virtual local area networks according to the target IP address. Since the target IP address belongs to the IP address pool of 10.1.3.1 to 10.1.3.100, while the virtual local area network corresponding to the IP address pool of 10.1.3.1 to 10.1.3.100 is the VLAN 30, the virtual local area network corresponding to the target IP address of 10.1.3.10 is the VLAN 30.

Step 304: The layer 3 switch sends the packet to the obtained virtual local area network.

Step 305: The layer 3 switch sends the packet to all the virtual local area networks in the aggregated VLAN.

In the embodiment of the present disclosure, before the layer 3 switch sends a packet, with the implementation of the technical solutions that correspondence between IP address information and virtual local area networks is searched according to a target Internet protocol (IP) address in the packet, and when a virtual local area network corresponding to the target IP address is obtained by searching according to the target IP address, the packet is sent to the virtual local area network, and otherwise, the packet is sent to all the virtual local area networks, the number of invalid packets sent by the layer 3 switch may be effectively reduced, and the sending performance of the packet in the aggregated VLAN scenario is improved, thereby reducing the influence of the invalid packets on the whole virtual local area network.

In the embodiment of the present disclosure, the IP address of the user device in each virtual local area network may be dynamically allocated by the layer 3 switch, and may also be allocated by the DHCP (Dynamic Host Configuration Protocol, dynamic host configuration protocol) server.

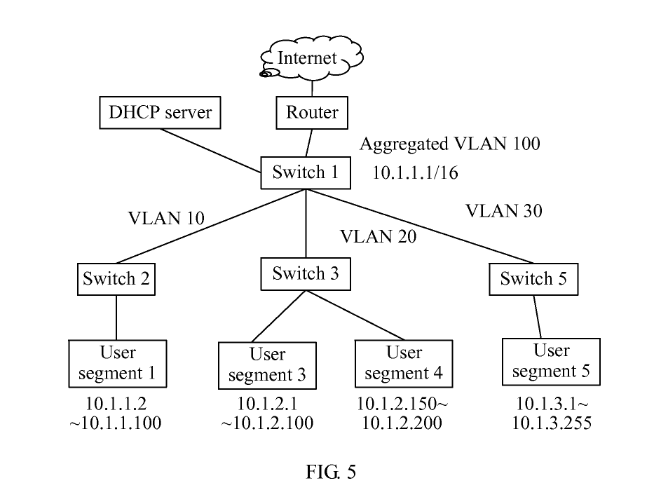

FIG. 5 is a schematic diagram of networking of an aggregated VLAN connected by layer 3 switches, which corresponds to the embodiment of the present disclosure. The networking of the aggregated VLAN shown in FIG. 5 is basically consistent with the networking of the aggregated VLAN shown in FIG. 2. A difference lies in that the layer 3 switch 1 in the networking of the aggregated VLAN shown in FIG. 5 is also connected with the DHCP server.

The DHCP server dynamically allocates the IP address for the user device as follows:

First, the network administrator of the aggregated VLAN may designate one or more corresponding IP address pools for the aggregated VLAN and each virtual local area network in the aggregated VLAN, where IP addresses in the IP address pool may be a segment of continuous IP addresses; in addition, IP address information in the IP address pool corresponding to the aggregated VLAN includes IP address information in the IP address pool corresponding to each virtual local area network in the aggregated VLAN; and the DHCP server stores the correspondence which is between the IP address pools and the virtual local area networks and is configured by the network administrator.

Then, in a case that the DHCP server stores the correspondence which is between the IP address pools and the virtual local area networks and is configured by the network administrator, the user device applies for an IP address to the DHCP server, and the DHCP server allocates a corresponding IP address for the user device when receiving the application of the user device. The user device sends a DHCP DISCOVER (Discover packet) to the DHCP server, where the DHCP DISCOVER includes information of the virtual local area network where the user device is located; after receiving the DHCP DISCOVER, the DHCP server searches the correspondence between the IP address pools and the virtual local area networks according to the information of the virtual local area network where the user device is located, obtains an IP address pool corresponding to the virtual local area network where the user device is located, and selects an unoccupied IP address for the user device from the found IP address pool; and afterwards, the DHCP server returns a response packet DHCP OFFER (Offer packet) of the DHCP DISCOVER to the user device, where the DHCP OFFER packet is used to notify the user device of the allocated IP address, and the DHCP OFFER packet includes configuration information such as the IP address of the user device.

When IP address resources in the IP address pool, found by the DHCP server, corresponding to the virtual local area network where the user device is located are insufficient, the DHCP server selects an IP address which is unoccupied and is not in the IP address pools corresponding to another virtual local area network for the user device from the IP address pool corresponding to the aggregated VLAN.

In addition, when the IP address pool corresponding to the virtual local area network where the user device is located cannot be obtained by searching the correspondence between the IP address pools and the virtual local area networks according to the information of the virtual local area network where the user device is located, the DHCP server selects an IP address which is unoccupied and is not in the IP address pools corresponding to another virtual local area network for the user device from the IP address pool corresponding to the aggregated VLAN.

Referring to the networking which is of the aggregated VLAN connected by layer 3 switches and is shown in FIG. 5, an IP address pool allocated for the VLAN 10 by the network administrator is 10.1.1.2 to 10.1.1.100, IP address pools allocated for the VLAN 20 are 10.1.2.1 to 10.1.2.100 and 10.1.2.150 to 10.1.2.200, respectively, an IP address pool allocated for the VLAN 30 is 10.1.3.1 to 10.1.3.255, and an IP address pool allocated for the aggregated VLAN 100 is 10.1.1.1/16. For example, a user device 1 sends a DHCP DISCOVER message to the DHCP server, where the DHCP DISCOVER message includes identification information of the VLAN 30, that is, the user device 1 belongs to the VLAN 30; after receiving the DHCP DISCOVER message, the DHCP server searches the correspondence between the IP address pools and the virtual local area networks to obtain that the IP address pool corresponding to the VLAN 30 is 10.1.3.1 to 10.1.3.255, and then selects an unoccupied IP address, for example, 10.1.3.8, for the user device 1 from 10.1.3.1 to 10.1.3.255, and sends a DHCP OFFER message to the user device 1 to notify the user device 1 that its IP address is 10.1.3.8.

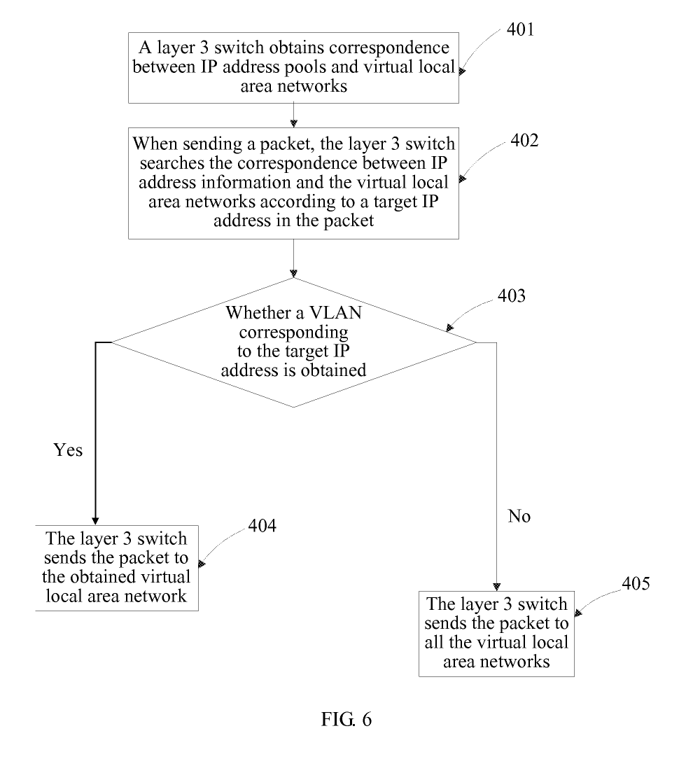

For a case that the IP address of the user device in the VLAN is dynamically allocated by the DHCP server, the embodiment of the present disclosure provides a method for sending a packet, and the method for sending the packet is applicable to the aggregated VLAN shown in FIG. 5. In addition, referring to FIG. 6, the following steps are included:

Step 401: The layer 3 switch which is configured with an aggregated VLAN obtains correspondence between IP address information and virtual local area networks. In the embodiment of the present disclosure, the correspondence between the IP address information and the virtual local area networks is correspondence between IP address pools and the virtual local area networks, and IP addresses in the IP address pool may be one or more segments of continuous IP addresses.

The obtaining, by the layer 3 switch, the correspondence between the IP address information and the virtual local area networks includes: obtaining, by the layer 3 switch, the correspondence between the IP address pools and the virtual local area networks from the DHCP server and saving the correspondence.

In specific implementation of this step, the layer 3 switch sends to the DHCP server a request for downloading the correspondence between the IP address pools and the virtual local area networks, where the DHCP server stores in advance the correspondence which is between the IP address pools and the virtual local area networks and is configured by the user, downloads the correspondence between the IP address pools and the virtual local area networks from the DHCP server, and saves the downloaded correspondence between the IP address pools and the virtual local area networks.

In the embodiment of the present disclosure, the DHCP server allows the user to modify, for a second time, the correspondence between the IP address pools and the virtual local area networks, and at the same time, the DHCP server may synchronize the correspondence which is between the IP address pools and the virtual local area networks and is obtained after the second modification to the layer 3 switch.

In the embodiment of the present disclosure, the correspondence which is between the IP address pools and the virtual local area networks and is saved by the layer 3 switch may be shown in Table 2.

Step 402: When sending a packet, the layer 3 switch searches the correspondence between the IP address information and the virtual local area networks according to a target IP address in the packet.

The layer 3 switch determines an IP address pool to which the target IP address belongs, and searches the correspondence between the IP address pools and the virtual local area networks according to the determined IP address pool.

Step 403: The layer 3 switch judges whether a virtual local area network corresponding to the target IP address is obtained by searching the correspondence between the IP address information and the virtual local area networks according to the target IP address in the packet.

If the virtual local area network corresponding to the target IP address is obtained by searching the correspondence between the IP address information and the virtual local area networks according to the target IP address, execute step 404.

If the virtual local area network corresponding to the target IP address cannot be obtained by searching the correspondence between the IP address information and the virtual local area networks according to the target IP address, execute step 405.

For example, if the packet forwarded by the layer 3 switch is an ARP request packet, and the target IP address in the packet is 10.1.3.10, the layer 3 switch searches the stored correspondence between the IP address pools and the virtual local area networks according to the target IP address. Since the target IP address belongs to the IP address pool of 10.1.3.1 to 10.1.3.100, and the virtual local area network corresponding to the IP address pool of 10.1.3.1 to 10.1.3.100 is the VLAN 30, the virtual local area network corresponding to the target IP address of 10.1.3.10 is the VLAN 30.

Step 404: The layer 3 switch sends the packet to the obtained virtual local area network.

Step 405: The layer 3 switch sends the packet to all the virtual local area networks in the aggregated VLAN.

In the embodiment of the present disclosure, before the layer 3 switch sends a packet, with the implementation of the technical solutions that information of virtual local area networks is searched through a target IP address in the packet to obtain a virtual local area network corresponding to the target IP address, and the packet is sent in the found virtual local area network, and otherwise, the packet is sent to all the virtual local area networks, the number of invalid packets sent by the layer 3 switch may be effectively reduced, and the sending performance of the packet in the aggregated VLAN scenario is improved, thereby reducing the influence of the invalid packets on the whole virtual local area network.

In the embodiment of the present disclosure, the IP address of the user device in each virtual local area network may be dynamically allocated by the layer 3 switch, and may also be allocated by the DHCP (Dynamic Host Configuration Protocol, dynamic host configuration protocol) server.

Referring to the schematic diagram which is of networking of the aggregated VLAN connected by layer 3 switches and is shown in FIG. 5, in the networking of the aggregated VLAN shown in FIG. 5, the user device applies for an IP address to the DHCP server, and the DHCP server allocates a corresponding IP address for the user device when receiving the application of the user device. The user device sends a DHCP DISCOVER (Discover packet) to the DHCP server; after receiving the DHCP DISCOVER, the DHCP server selects an unoccupied IP address for the user device from a preset IP address pool; and afterwards, the DHCP server returns a response packet DHCP OFFER (Offer packet) of the DHCP DISCOVER to the user device, where the DHCP OFFER packet includes configuration information such as the IP address of the user device.

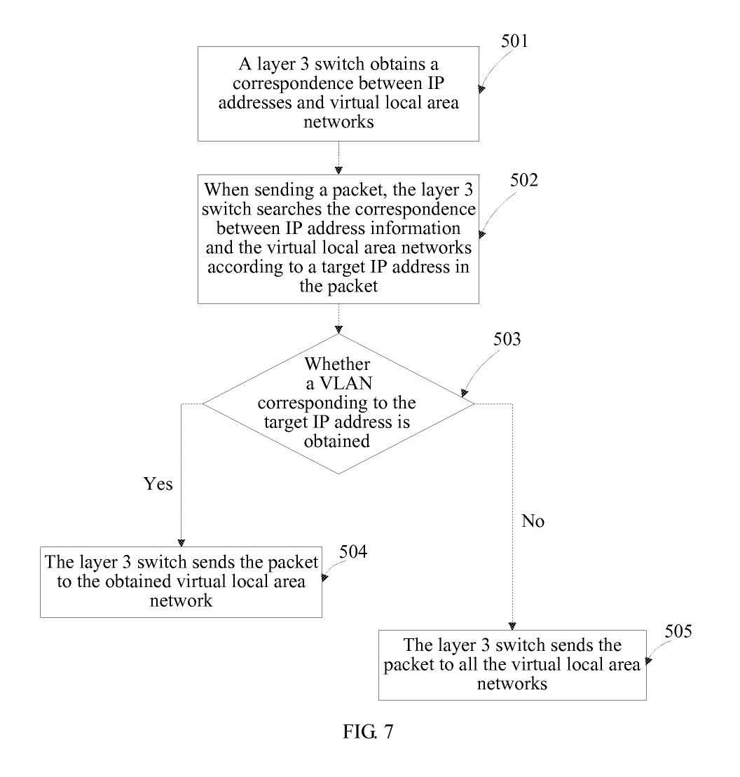

For the case that the IP address of the user device in the VLAN is dynamically allocated by the DHCP server, the embodiment of the present disclosure provides a method for sending a packet, and the method for sending a packet is applicable to the aggregated VLAN shown in FIG. 5. In addition, referring to FIG. 7, the following steps are included:

Step 501: A layer 3 switch which is configured with an aggregated VLAN obtains correspondence between IP address information and virtual local area networks. In the embodiment of the present disclosure, the correspondence between the IP address information and the virtual local area networks is correspondence between IP addresses and the virtual local area networks.

The obtaining, by the layer 3 switch, the correspondence between the IP address information and the virtual local area networks includes: intercepting, by the layer 3 switch, an Offer packet sent by the DHCP server, and obtaining the correspondence between the IP addresses and the virtual local area networks from the intercepted Offer packet and saving the correspondence.

In the embodiment of the present disclosure, the correspondence which is between the IP addresses and the virtual local area networks and is saved by the layer 3 switch may be shown in Table 3.

TABLE 3
Correspondence between IP addresses
and virtual local area networks

| IP Address | Virtual Local Area Network |
|---|---|
| 10.1.1.2 | VLAN 10 |
| 10.1.1.100 | VLAN 10 |
| . . . | . . . |
| 10.1.2.1 | VLAN 20 |
| 10.1.2.10 | VLAN 20 |
| . . . | . . . |
| 10.1.3.5 | VLAN 30 |
| . . . | . . . |
| 10.1.3.250 | VLAN 30 |
| 10.1.3.1 | VLAN 30 |
| . . . | . . . |

Step 502: When sending a packet, the layer 3 switch searches the correspondence between the IP address information and the virtual local area networks according to a target IP address in the packet.

The layer 3 switch searches the correspondence between the IP addresses and the virtual local area networks according to the target IP address.

Step 503: The layer 3 switch judges whether a virtual local area network corresponding to the target IP address is obtained by searching the correspondence between the IP address information and the virtual local area networks according to the target IP address in the packet.

If the virtual local area network corresponding to the target IP address is obtained by searching the correspondence between the IP address information and the virtual local area networks according to the target IP address, execute step 504.

If the virtual local area network corresponding to the target IP address cannot be obtained by searching the correspondence between the IP address information and the virtual local area networks according to the target IP address, execute step 505.

For example, if the packet forwarded by the layer 3 switch is an ARP request packet, and the target IP address in the packet is 10.1.3.10, the layer 3 switch searches the stored correspondence between the IP addresses and the virtual local area networks according to the target IP address, for example, the virtual local area network corresponding to the target IP address of 10.1.3.10 is the VLAN 30.

Step 504: The layer 3 switch sends the packet to the obtained virtual local area network.

Step 505: The layer 3 switch sends the packet to all the virtual local area networks in the aggregated VLAN.

In the embodiment of the present disclosure, before the layer 3 switch sends a packet, with the implementation of the technical solutions that correspondence between IP address information and virtual local area networks is searched according to a target Internet protocol (IP) address in the packet, and when a virtual local area network corresponding to the target IP address is obtained by searching according to the target IP address, the packet is sent to the virtual local area network, and otherwise, the packet is sent to all the virtual local area networks, the number of invalid packets sent by the layer 3 switch may be effectively reduced, and the sending performance of the packet in the aggregated VLAN scenario is improved, thereby reducing the influence of the invalid packets on the whole virtual local area network.

### Embodiment 3

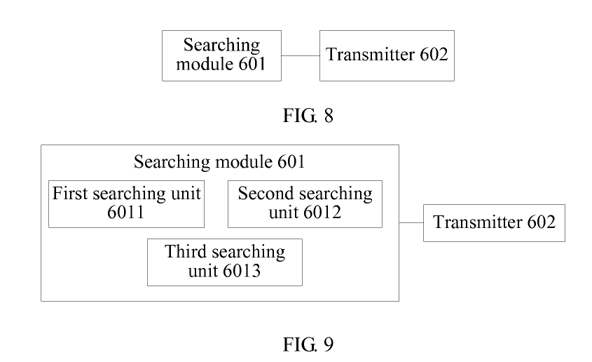

Referring to FIG. 8, a switch is shown. The switch is the same as a layer 3 switch in Method Embodiment 2, the switch is configured with an aggregated VLAN and includes a searching module 601 and a transmitter 602.

The searching module 601 is configured to, when sending a packet, search correspondence between IP address information and virtual local area networks according to a target Internet protocol (IP) address in the packet.

The transmitter 602 is configured to, if the searching module 601 obtains a virtual local area network corresponding to the target IP address by searching the correspondence between the IP address information and the virtual local area networks according to the target IP address in the packet, send the packet to the virtual local area network, and if the searching module 601 cannot obtain the virtual local area network corresponding to the target IP address by searching the correspondence between the IP address information and the virtual local area networks according to the target IP address in the packet, send the packet to all the virtual local area networks in the aggregated VLAN.

Referring to FIG. 9, the searching module 601 may include:

a first searching unit 6011, configured to, when the IP address information is an IP address segment, determine an IP address segment to which the target IP address belongs, and search correspondence between IP address segments and the virtual local area networks according to the determined IP address segment; or

a second searching unit 6012, configured to, when the IP address information is an IP address pool, determine an IP address pool to which the target IP address belongs, and search correspondence between IP address pools and the virtual local area networks according to the determined IP address pool; or

a third searching unit 6013, configured to, when the IP address information is an IP address, search correspondence between IP addresses and the virtual local area networks according to the target IP address.

In the embodiment of the present disclosure, a network administrator of an aggregated VLAN may statically configure one or more corresponding IP network segments for the aggregated VLAN and each virtual local area network in the aggregated VLAN, where the IP network segment corresponding to the aggregated VLAN includes the IP network segment corresponding to each virtual local area network in the aggregated VLAN. In a case of statically configuring the IP network segment in the foregoing, when a user device joins a certain VLAN, the network administrator may select an unoccupied IP address from the IP network segment corresponding to the VLAN and statically allocate the IP address to the newly joined user device.

For the case that the IP address of the user device in the VLAN is statically allocated, the switch in the embodiment of the present disclosure further includes a first obtaining module, which is configured to configure and save the correspondence between the IP address segments and the virtual local area networks.

In the embodiment of the present disclosure, the IP address of the user device in each virtual local area network may be statically allocated by the network administrator, and may also be dynamically allocated by the layer 3 switch. The layer 3 switch is a switch which has a DHCP (Dynamic Host Configuration Protocol, dynamic host configuration protocol) function. The layer 3 switch dynamically allocates the IP address of the user device as follows.

First, the network administrator of the aggregated VLAN may designate one or more corresponding IP address pools for the aggregated VLAN and each virtual local area network in the aggregated VLAN, where IP addresses in the IP address pool may be a segment of continuous IP addresses; in addition, IP address information in the IP address pool corresponding to the aggregated VLAN includes IP address information in the IP address pool corresponding to each virtual local area network in the aggregated VLAN; and the layer 3 switch stores the correspondence which is between the IP address pools and the virtual local area networks and is configured by the network administrator. Then, in a case that the layer 3 switch stores the correspondence which is between the IP address pools and the virtual local area networks and is configured by the network administrator, the user device applies for an IP address to the layer 3 switch, and the layer 3 switch allocates a corresponding IP address for the user device when receiving the application of the user device. The user device sends a DHCP DISCOVER (Discover packet) to the layer 3 switch, where the DHCP DISCOVER includes information of the virtual local area network where the user device is located; after receiving the DHCP DISCOVER, the layer 3 switch searches the correspondence between the IP address pools and the virtual local area networks according to the information of the virtual local area network where the user device is located, obtains an IP address pool corresponding to the virtual local area network where the user device is located, and selects an unoccupied IP address for the user device from the found IP address pool; and afterwards, the layer 3 switch returns a response packet DHCP OFFER (Offer packet) of the DHCP DISCOVER to the user device, where the DHCP OFFER packet is used to notify the user device of the allocated IP address, and the DHCP OFFER packet includes configuration information such as the IP address of the user device.

For the case that the IP address of the user device in the VLAN is dynamically allocated by the layer 3 switch, the switch in the embodiment of the present disclosure further includes a second obtaining module, which is configured to configure and save the correspondence between the IP address pools and the virtual local area networks.

In the embodiment of the present disclosure, the IP address of the user device in each virtual local area network may be dynamically allocated by the layer 3 switch, and may also be allocated by a DHCP (Dynamic Host Configuration Protocol, dynamic host configuration protocol) server.

FIG. 5 is a schematic diagram of networking of an aggregated VLAN connected by layer 3 switches, which is corresponding to the embodiment of the present disclosure. The networking of the aggregated VLAN shown in FIG. 5 is basically consistent with the networking of the aggregated VLAN shown in FIG. 2. A difference lies in that, a layer 3 switch 1 in the networking of the aggregated VLAN shown in FIG. 5 is also specifically connected with the DHCP server.

The DHCP server dynamically allocates the IP address for the user device as follows.

First, the network administrator of the aggregated VLAN may designate one or more corresponding IP address pools for the aggregated VLAN and each virtual local area network in the aggregated VLAN, where IP addresses in the IP address pool may be a segment of continuous IP addresses; in addition, IP address information in the IP address pool corresponding to the aggregated VLAN includes IP address information in the IP address pool corresponding to each virtual local area network in the aggregated VLAN; and the DHCP server stores the correspondence which is between the IP address pools and the virtual local area networks and is configured by the network administrator.

Then, in the case that the DHCP server stores the correspondence which is between the IP address pools and the virtual local area networks and is configured by the network administrator, the user device applies for an IP address to the DHCP server, and the DHCP server allocates a corresponding IP address for the user device when receiving the application of the user device. The user device sends a DHCP DISCOVER (Discover packet) to the DHCP server, where the DHCP DISCOVER includes information of the virtual local area network where the user device is located; after receiving the DHCP DISCOVER, the DHCP server searches the correspondence between the IP address pools and the virtual local area networks according to the information of the virtual local area network where the user device is located, obtains an IP address pool corresponding to the virtual local area network where the user device is located, and selects an unoccupied IP address for the user device from the found IP address pool; and afterwards, the DHCP server returns a response packet DHCP OFFER (Offer packet) of the DHCP DISCOVER to the user device, where the DHCP OFFER packet is used to notify the user device of the allocated IP address, and the DHCP OFFER packet includes configuration information such as the IP address of the user device.

For the case that the IP address of the user device in the VLAN is dynamically allocated by the DHCP server, the switch in the embodiment of the present disclosure further includes the second obtaining module, which is further configured to obtain the correspondence between the IP address pools and the virtual local area networks from the dynamic host configuration protocol server and save the correspondence.

In the embodiment of the present disclosure, the IP address of the user device in each virtual local area network may be dynamically allocated by the layer 3 switch, and may also be allocated by the DHCP (Dynamic Host Configuration Protocol, dynamic host configuration protocol) server.

Referring to the schematic diagram which is of networking of the aggregated VLAN connected by layer 3 switches and is shown in FIG. 5, in the networking of the aggregated VLAN shown in FIG. 5, the user device applies for an IP address to the DHCP server, and the DHCP server allocates a corresponding IP address for the user device when receiving the application of the user device. The user device sends a DHCP DISCOVER (Discover packet) to the DHCP server; after receiving the DHCP DISCOVER, the DHCP server selects an unoccupied IP address for the user device from a preset IP address pool; and afterwards, the DHCP server returns a response packet DHCP OFFER (Offer packet) of the DHCP DISCOVER to the user device, where the DHCP OFFER packet includes configuration information such as the IP address of the user device.

For the case that the IP address of the user device in the VLAN is dynamically allocated by the DHCP server, the switch in the embodiment of the present disclosure further includes a third obtaining module, which is configured to intercept an Offer packet sent by the dynamic host configuration protocol server, and obtain the correspondence between the IP addresses and the virtual local area networks from the Offer packet and save the correspondence.

In the embodiments of the present disclosure, with the implementation of the technical solutions that correspondence between IP address information and virtual local area networks is searched according to a target Internet protocol (IP) address of a packet, and when a virtual local area network corresponding to the target IP address is obtained by searching according to the target IP address, the packet is sent to the virtual local area network, and otherwise, the packet is sent to all the virtual local area networks, the number of invalid packets that are sent may be effectively reduced, and the sending performance of the packet in the aggregated VLAN scenario is improved, thereby reducing the influence of the invalid packets on the whole virtual local area network.

Persons of ordinary skill in the art may understand that all or a part of the steps of the foregoing embodiments may be implemented through hardware, and may also be implemented by a program instructing relevant hardware. The program may be stored in a computer readable storage medium. The foregoing-mentioned storage medium may be a read-only memory, a magnetic disk, or a compact disk.

The foregoing description is only exemplary embodiments of the present disclosure and is not intended to limit the present disclosure. Any modification, equivalent replacement, or improvement made within the spirit and principle of the present disclosure shall fall within the protection scope of the present disclosure.

What is claimed is:

1. A method for sending a packet, wherein the method is performed by a layer 3 switch configured with an aggregated virtual local area network (VLAN) containing a plurality of VLANs, and the method comprises:
searching information regarding correspondence between IP addresses and the VLANs to determine if there is a VLAN in the aggregated VLAN that corresponds to a target IP address in a packet; and
if there is a VLAN that corresponds to the target IP address, sending the packet to only that VLAN.

2. The method according to claim 1, wherein the information regarding correspondence between IP addresses and the VLANs identifies information regarding correspondence between IP segments and the VLANs, and the searching step comprises:
determining an IP address segment to which the target IP address belongs; and
searching the information regarding correspondence between IP segments and the VLANs according to the determined IP address segment.

3. The method according to claim 1, wherein the information regarding correspondence between IP addresses and the VLANs identifies information regarding correspondence between IP address pools and the VLANs, and the searching step comprises:
determining an IP address pool to which the target IP address belongs; and
searching the information regarding correspondence between IP address pools and the VLANs according to the determined pool.

4. The method according to claim 1, wherein the searching step comprises:
searching the information regarding correspondence between IP addresses and the VLANs according to the target IP address.

5. The method according to claim 2, wherein before the searching the information regarding correspondence between IP segments and the VLANs according to the determined IP address segment, the method further comprises:
configuring and saving the information regarding correspondence between IP segments and the VLANs.

6. The method according to claim 3, wherein before the searching the information regarding correspondence between IP address pools and the VLANs according to the determined pool, the method further comprises:
obtaining the information regarding correspondence between IP address pools and the VLANs from a dynamic host configuration protocol server and saving the information.

7. The method according to claim 4, wherein before the searching the information regarding correspondence between the IP addresses and the VLANs according to the target IP address, the method further comprises:
intercepting an Offer packet sent by a dynamic host configuration protocol server, and obtaining the information regarding correspondence between the IP addresses and the virtual local area networks from the Offer packet and saving the information.

8. A layer 3 switch, wherein the switch comprises a searching module and a transmitter, wherein the switch is configured with an aggregated virtual local area network (VLAN) containing a plurality of VLANs,
the searching module is configured to, search information regarding correspondence between IP addresses and the VLANs to determine if there is a VLAN in the aggregated VLAN that corresponds to a target IP address in a packet; and
the transmitter is configured to, if the searching module obtains a VLAN that corresponds to the target IP address, send the packet to only that VLAN.

9. The switch according to claim 8, wherein the searching module comprises:
a searching unit, configured to, when the information regarding correspondence between IP addresses and the VLANs identifies information regarding correspondence between IP segments and the VLANs, determine an IP address segment to which the target IP address belongs, and search the information regarding correspondence between IP segments and the VLANs according to the determined IP address segment.

10. The switch according to claim 8, wherein the searching module comprises:
a searching unit, configured to, when the information regarding correspondence between IP addresses and the VLANs identifies information regarding correspondence between IP address pools and the VLANs, determine an IP address pool to which the target IP address belongs, and search the information regarding correspondence between IP address pools and the VLANs according to the determined IP address pool.

11. The switch according to claim 8, wherein the searching module comprises:
a searching unit, configured to, search the information regarding correspondence between IP addresses and the VLANs according to the target IP address.

12. The switch according to claim 9, further comprising:
a obtaining module, configured to configure and save the information regarding correspondence between IP segments and the VLANs.

13. The switch according to claim 10, further comprising:
a obtaining module, configured to obtain the information regarding correspondence between IP address pools and the VLANs from a dynamic host configuration protocol server and save the information.

14. The switch according to claim 11, further comprising:
a obtaining module, configured to intercept an Offer packet sent by a dynamic host configuration protocol server, and obtain the information regarding correspondence between IP addresses and the VLANs from the Offer packet and save the information.
